(19) United States
(12) Patent Application Publication
(10) Pub. No.: US 2026/0359106 A1
(43) Pub. Date: Nov. 12, 2026

(54) COMPUTER-IMPLEMENTED TASK SCHEDULING METHOD

(71) Applicant: Airbus (S.A.S.), Blagnac (FR)

(72) Inventor: Markus Klügel, München (DE)

(21) Appl. No.: 18/427,984

(22) Filed: Jan. 31, 2024

(30) Foreign Application Priority Data
Feb. 1, 2023 (EP) 23154382.8

(51) Int. Cl. G06F 9/48

(52) U.S. Cl. CPC G06F 9/4881

(57) ABSTRACT

A computer-implemented task scheduling method for data processing device with computational hardware components and for scheduling a set R[t] of computational tasks at a given time t∈T_{act}, T_{act} being a set of time intervals each of length Δt, among a set A[t] of the computational hardware components each available at the given time t∈T_{act} for executing a computational task associated with a corresponding task quality class c∈C, C being a set of task quality classes, each one and each computational hardware component associated with a processing time value T_{proc} in terms of Δt, indicative of duration for processing a computational task by the computational hardware component. Each task quality class c∈C and each computational hardware component are associated with a corresponding utility value U_{proc} indicative of a cost or added value induced by processing a computational task of the corresponding class c∈C by the corresponding computational hardware component.

### TECHNICAL FIELD

The subject matter herein relates to a computer-implemented task scheduling method. The subject matter herein further relates to a task scheduling device, a data processing device, an air vehicle, a computer program, and a computer-readable data carrier.

### BACKGROUND

A computer may have a set of different computing units, i.e., central processing units (CPUs), field-programmable gate arrays (FPGAs) or integrated circuits (ICs), or a combination of the aforementioned, that all can realize, for example, the same cryptographic functions, e.g., signing a piece of data, verifying a signature or secure key exchange. In certain situations, the computer may receive a high number of requests to execute such functions.

Multicore processing considers the task of distributing computational tasks on multiple cores. The key questions here are when and on which core to start a computing thread, task or subtask, such that a specific utility (e.g., the overall computation time, energy) is optimized. Hardware acceleration deals with the design of specialized hardware that realizes a sub-function required to execute a specific task. The goals here are to identify the functions that would benefit most from hardware acceleration and to implement and integrate them efficiently into the overall computing architecture.

### SUMMARY

An object of the disclosure herein is to provide an improved task scheduling method, in particular for a heterogeneous computational environment with different computing units.

To achieve this object, the disclosure herein provides a computer-implemented task scheduling method as disclosed herein. A task scheduling device, a data processing device, an air vehicle, a computer program, and a computer-readable data carrier are disclosed herein.

Advantageous embodiments are disclosed herein.

In one aspect, the disclosure herein provides a computer-implemented task scheduling method for use in a data processing device with a plurality of computational hardware components and for scheduling a set R[t] of computational tasks at a given time t∈T_{act}, T_{act} being a set of discrete time intervals each of length Δt, among a set A[t] of the computational hardware components that are available at the given time t∈T_{act} and configured for executing any one of the computational tasks, each computational task being associated with a corresponding task quality class c∈C, C being a set of task quality classes, each task quality class c∈C and each computational hardware component being associated with a corresponding processing time value T_{proc} in terms of Δt, the associated processing time value T_{proc} being indicative of a duration for processing any one computational task of the corresponding class c∈C by the corresponding computational hardware component, each task quality class c∈C and each computational hardware component being further associated with a corresponding utility value U_{proc}, the associated utility value U_{proc} being indicative of a cost or added value that is induced by processing any one computational task of the corresponding class c∈C by the corresponding computational hardware component, the method comprising:
a) associating each task quality class c∈C with a corresponding computing time limit value Dₗᵢₘᵢₜ in terms of Δt;
b) at the given time t∈T_{act}, defining for each computational task r∈R[t] and each hardware component a∈A[t], a corresponding decision variable xᵣₐ[t]∈{0, 1}, wherein xᵣₐ=1, if the computational task r∈R[t] is allocated to computational hardware component a∈A[t], and xᵣₐ=0 otherwise, under the constraint that each task r∈R[t] is allocatable to at most one computational hardware component a∈A[t] and each computational hardware component a∈A[t] is to assigned at most one computational task r∈R[t];
c) at the given time t∈T_{act}, whereas cᵣ∈C being the associated task quality class c of r∈R[t], determining decision variable data x[t] by solving a maximization problem including the associated utility value U_{proc} of cᵣ∈C and a∈A[t], for all r∈R[t] and a∈A[t], under the condition:

Σ_{a∈A[t]}xᵣₐ[t]T_{c}_{ᵣ}ₐ+(1−Σ_{a∈A[t]}xᵣₐ[t])(D_{c}_{ᵣ}+1)≤D_{c}_{ᵣ}, for all r∈R[t],

with x[t]∈F[t], F[t] being the set of all decision variable data satisfying the constraint in step b) at the given time t∈T_{act}, T_{c}_{ᵣ}ₐ being the associated processing time T_{proc} of cᵣ∈C and a∈A[t], and D_{c}_{ᵣ} being the associated computing time limit value Dₗᵢₘᵢₜ of cᵣ∈C; and
d) at the given time t∈T_{act}, scheduling the set R[t] of computational tasks among the set A[t] of computational hardware components based on the determined decision variable data x[t].

Preferably, step c) further comprises:
c1) at the given time t∈T_{act}, solving the maximization problem according to:

$${max}_{x [ t ]} {\sum }_{r ∈ R [ t ]} {\sum }_{a ∈ A [ t ]} {x}_{ra} [ t ] {U}_{{c}_{r} a} ,$$

with U_{c}_{ᵣ}ₐ being the associated utility value U_{proc} of cᵣ∈C and a∈A[t].

Preferably, step c) further comprises:
c2) at the given time t∈T_{act}, solving a bipartite matching problem as maximization problem.

Preferably, step c) further comprises:
c3) at the given time t∈T_{act}, solving the bipartite matching problem according to:

$${max}_{x [ t ]} {\sum }_{r ∈ R [ t ]} {\sum }_{a ∈ A [ t ]} {x}_{ra} [ t ] ( {U}_{{c}_{r} a} - {V}_{{c}_{r}} [ t ] [ {T}_{{c}_{r} a} - {D}_{{c}_{r}} - 1 ] ) ,$$

with U_{c}_{ᵣ}ₐ being the associated utility value U_{proc} of cᵣ∈C and a∈A[t], T_{c}_{ᵣ}ₐ being the associated processing time T_{proc} of cᵣ∈C and a∈A[t], D_{c}_{ᵣ} being the associated computing time limit value Dₗᵢₘᵢₜ of cᵣ∈C, and V_{c}_{ᵣ}[t] being a virtual queue variable of cᵣ∈C in terms of per Δt.

Preferably, step c) further comprises:
c4) at the given time t∈T_{act}, iteratively computing for each class cᵣ∈C the associated virtual queue variable V_{c}_{ᵣ}[t] in terms of per Δt according to:

$${V}_{{c}_{r}} [ t ] = {max}_{x [ t ]} \{ {V}_{{c}_{r}} [ t - Δ t ] - λ ( {D}_{{c}_{r}} - {\sum }_{a ∈ A [ t ]} {x}_{ra} [ t - Δ t ] {T}_{{c}_{r} a} - ( 1 - {\sum }_{a ∈ A [ t ]} {x}_{ra} ) ( {D}_{{c}_{r}} + 1 ) ) , 0 \} ,$$

wherein λ≥0 corresponds to a tuning parameter of the iteration.

Preferably, the associated computing time limit value Dₗᵢₘᵢₜ corresponds to an average duration for processing any one computational task of the corresponding class c∈C by each of the computational hardware components in the data processing device.

Preferably, the associated utility value U_{proc} corresponds to an associated priority value P_{proc} indicative of a priority that has every computational task of the corresponding class c∈C on the corresponding computational hardware component.

Preferably, the associated utility value U_{proc} corresponds to an associated priority value P_{proc} indicative of a priority that has every computational task of the corresponding class c∈C on each of the computational hardware components in the data processing device.

Preferably, each computational task includes a cryptographic computation function.

In another aspect, the disclosure herein provides a task scheduling device for carrying out the method of any of the preceding embodiments.

In another aspect, the disclosure herein provides a data processing device, comprising the task scheduling device and a plurality of computational hardware components.

Preferably, the plurality of computational hardware components include one or more of a CPU, a GPU, a FPGA, an IC, and/or the like.

Preferably, at least two of the plurality of computational hardware components have for at least one task quality class c∈C differing corresponding processing time values T_{proc} and/or differing corresponding processing time values U_{proc}.

In another aspect, the disclosure herein provides an air vehicle, in particular an aircraft, comprising the task scheduling device and/or the data processing device.

In another aspect, the disclosure herein provides a computer program comprising instructions which, when the program is executed by a computer, cause the computer to carry out the method of any of the preceding embodiments.

In another aspect, the disclosure herein provides a computer-readable data carrier having stored thereon the computer program.

Embodiments of the disclosure herein preferably have the following advantages and effects:

Compared to traditional multicore processors, hardware accelerators (FPGAs or ICs) can have several advantages: they can significantly improve performance and energy consumption for specific tasks. They have the potential to implement a pipelining structure, which allows a higher task throughput. Also, they can provide a trusted implementation of a cryptographic routine, as they are not corrupted as easily as software. On the other hand, data transfer to accelerators often forms a bottleneck that may slow down their use, neglecting or even countering the benefit of hardware implementation. An advantage of preferred embodiments of the disclosure herein is to make use of the available computing power by taking into account the properties of the different implementation options of CPU, FPGA and IC. By assigning the tasks to the correct piece of hardware at the correct point in time, the overall task throughput and/or energy consumption can be reduced.

Preferred embodiments of the disclosure herein may comprise a computational block that interacts with all associated CPUs, FPGAs and ICs to identify their computation status, a decision routine to decide on which device the next task will be executed, and an interface to transfer the task to the related piece of hardware.

Preferred embodiments of the disclosure herein may be considered in a task scheduler for cryptographic functions. Preferred embodiments can be used in the field of “post-quantum” (i.e., quantum safe) cryptography, but can as well be extended to classical cryptography. As such, preferred embodiments of the disclosure herein may be related to the field of hardware-software codesign, hardware acceleration and multi-core computing, but in the field of cryptography. Preferably, embodiments of the disclosure herein are applicable to any product that has a hardware acceleration for cryptographic functions. Preferred embodiments of the disclosure herein target cryptographic functions in the electronic bay of an aircraft or in the cloud of a ground station counterpart. They could be implemented, e.g., in an aircraft data platform.

### BRIEF DESCRIPTION OF THE DRAWINGS

Embodiments of the disclosure herein are now explained in more detail with reference to the accompanying drawings of which:

FIG. 1 shows an embodiment of a data processing device;

FIG. 2 shows an embodiment of a computer-implemented task scheduling method;

FIG. 3 shows an embodiment of an aeronautic system;

FIG. 4 shows a server of the system of FIG. 3;

FIG. 5 shows a process of symmetric key exchange;

FIG. 6 shows a process of signature generation and verification;

FIG. 7 shows a process with a task scheduling device; and

FIG. 8 shows another process with the task scheduling device.

### DETAILED DESCRIPTION

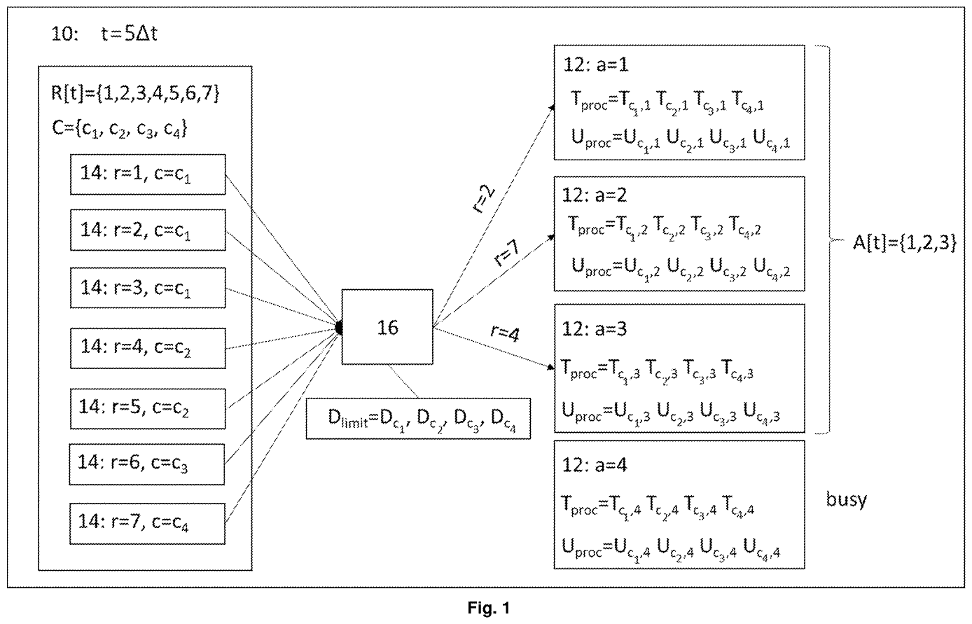

FIG. 1 shows an embodiment of a data processing device 10.

The data processing device 10 includes a plurality of computational hardware components 12. The computational hardware components 12 are processing units and may include one or more of a central processing unit 28 (CPU), a graphics processing unit (GPU), a field-programmable gate array 30 (FPGA), an integrated circuit 32 (IC), and/or any other kind of processing unit.

Each computational hardware component 12 is configured for executing a computational task 14. The computational task 14 can include, for example, a cryptographic computation function.

Each computational tasks 14 can be assigned a task quality class c∈C, C being a set of task quality classes. Each task quality class c∈C and each computational hardware component 12 is associated with a corresponding processing time value T_{proc} in terms of a discrete time interval of length Δt. The associated processing time value T_{proc} is indicative of a duration for processing any one computational task 14 of the corresponding class c∈C by the corresponding computational hardware component 12.

Each task quality class c∈C and each computational hardware component 12 is further associated with a corresponding utility value U_{proc}. The associated utility value U_{proc} may be indicative of a cost or added value that is induced by processing any one computational task 14 of the corresponding class c∈C by the corresponding computational hardware component 12. For example, U_{proc}=−E may indicate that assigning any one computational task 14 of the corresponding class c∈C to the corresponding computational hardware component 12 induces an energy cost of E>0. Likewise, a value U_{proc}=1 may indicate that assigning any one computational task 14 of the corresponding class c∈C to the corresponding computational hardware component 12 adds a value of finishing off one computational task 14.

Alternatively or additionally, the associated utility value U_{proc} may correspond to an associated priority value P_{proc} indicative of a priority that has every computational task 14 of the corresponding class c∈C on the corresponding computational hardware component 12.

Alternatively or additionally, the associated utility value U_{proc} may correspond to an associated priority value P_{proc} indicative of a priority that has every computational task 14 of the corresponding class c∈C on each of the computational hardware components 12 in the data processing device 10.

In the present example, the data processing device 10 is configured as a heterogeneous environment in the sense that the corresponding processing time value T_{proc} for one computational task 14 of a given task quality class c∈C may differ between the computational hardware components 12 and/or the corresponding utility value U_{proc} for one computational task 14 of a given task quality class c∈C may differ between the computational hardware components 12.

The data processing device 10 further includes a task scheduling device 16. The task scheduling device 16 is configured for scheduling a set R[t] of computational tasks 14 at a given time t∈T_{act}, T_{act} being a set of the discrete time intervals Δt, among a set A[t] of the computational hardware components 12 each available at the given time t∈T_{act}. In FIG. 1, t=5Δt as example.

Since the associated processing time value T_{proc} and/or the associated utility value U_{proc} for a computational task r∈R[t], with cᵣ∈C being the associated task quality class c of r∈R[t], may differ between the available computational hardware components a∈A[t], the question is how to schedule the set R[t] of computational tasks 14 at the given time t∈T_{act} among the set A[t] of computational hardware components 12.

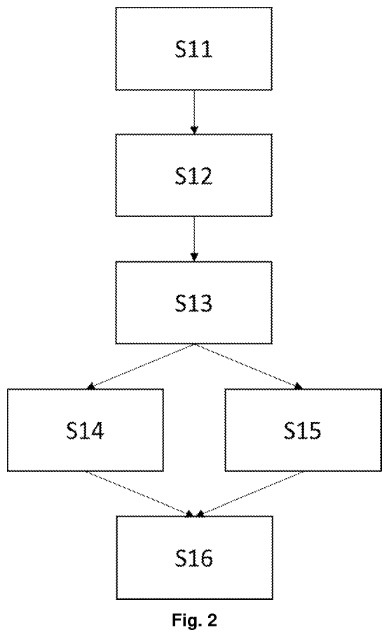

FIG. 2 shows an embodiment of a computer-implemented task scheduling method.

In a step S11, the method includes:
Associating each task quality class c∈C with a corresponding computing time limit value Dₗᵢₘᵢₜ in terms of Δt.

The corresponding computing time limit value Dₗᵢₘᵢₜ preferably is a positive number. Dₗᵢₘᵢₜ may correspond to an average duration for processing any one computational task 14 of the corresponding class c∈C by each of the computational hardware components 12 in the data processing device 10. Dₗᵢₘᵢₜ may, for example, indicate that it is acceptable to process any one computational task 14 of the corresponding class c∈C by a computational hardware component 12 when T_{proc}≤Dₗᵢₘᵢₜ. Dₗᵢₘᵢₜ can also be regarded as a target value which is set externally. A high value of Dₗᵢₘᵢₜ may allow to process more computational tasks 14 of different corresponding classes c∈C by a given computational hardware component 12, whereas a low value Dₗᵢₘᵢₜ limits the computational tasks 14 which are allowed to be processed by a given computational hardware component 12, to less corresponding classes c∈C.

In a step S12, the method includes:
At the given time t∈T_{act}, defining for each computational task r∈R[t] and each hardware component a∈A[t], a corresponding decision variable xᵣₐ[t]∈{0, 1}, wherein xᵣₐ=1, if the computational task r∈R[t] is allocated to computational hardware component a∈A[t], and xᵣₐ=0 otherwise, under the constraint that each task r∈R[t] is allocatable to at most one computational hardware component a∈A[t] and each computational hardware component a∈A[t] is to assigned at most one computational task r∈R[t].

In a step S13, the method includes:
At the given time t∈T_{act}, whereas cᵣ∈C being the associated task quality class c of r∈R[t], determining decision variable data x[t] by solving a maximization problem including the associated utility value U_{proc} of cᵣ∈C and a∈A[t], for all r∈R[t] and a∈A[t], under the condition: Σ_{a∈A[t]}xᵣₐ[t]T_{c}_{ᵣ}ₐ+(1−Σ_{a∈A}[t]xᵣₐ[t])(D_{c}_{ᵣ}+1)≤D_{c}_{ᵣ}, for all r∈R[t], with x[t]∈F[t], F[t] being the set of all decision variable data satisfying the constraint in step S12 at the given time t∈T_{act}, T_{c}_{ᵣ}ₐ being the associated processing time T_{proc} of cᵣ∈C and a∈A[t], and D_{c}_{ᵣ} being the associated computing time limit value Dₗᵢₘᵢₜ of cᵣ∈C.

The trivial solution of xᵣₐ[t]=0 for all a∈A[t] is excluded by contradiction D_{c}_{ᵣ}+1≤D_{c}_{ᵣ} for a given r∈R[t]. This guarantees that at least one computational task r∈R[t] is allocated, even if each computational task r∈R[t] induced a cost.

In a step S14, the method may include as a first possible solution:
At the given time t∈T_{act}, solving the maximization problem according to:

$${max}_{x [ t ]} {\sum }_{r ∈ R [ t ]} {\sum }_{a ∈ A [ t ]} {x}_{ra} [ t ] {U}_{{c}_{r} a} ,$$

with U_{c}_{ᵣ}ₐ being the associated utility value U_{proc} of cᵣ∈C and a∈A[t].

In a step S15, the method may include as a second possible solution:
At the given time t∈T_{act}, solving the maximization problem according to:

$${max}_{x [ t ]} {\sum }_{r ∈ R [ t ]} {\sum }_{a ∈ A [ t ]} {x}_{ra} [ t ] ( {U}_{{c}_{r} a} - {V}_{{c}_{r}} [ t ] [ {T}_{{c}_{r} a} - {D}_{{c}_{r}} - 1 ] ) ,$$

with U_{c}_{ᵣ}ₐ being the associated utility value U_{proc} of cᵣ∈C and a∈A[t], T_{c}_{ᵣ}ₐ being the associated processing time T_{proc} of cᵣ∈C and a∈A[t], Dₑ, being the associated computing time limit value Dₗᵢₘᵢₜ of cᵣ∈C, and V_{c}_{ᵣ}[t] being a virtual queue variable of cᵣ∈C in terms of per Δt.

In this form, the maximization problem represents a bipartite matching or assignment problem. The bipartite matching or assignment problem is a combinatorial optimization problem that may be solved, for example, by the Hungarian algorithm.

In step S15, V_{c}_{ᵣ}[t] is iteratively computed for each class cᵣ∈C according to:

$${V}_{{c}_{r}} [ t ] = {max}_{x [ t ]} \{ {V}_{{c}_{r}} [ t - Δ t ] - λ ( {D}_{{c}_{r}} - {\sum }_{a ∈ A [ t ]} {x}_{ra} [ t - Δ t ] {T}_{{c}_{r} a} - ( 1 - {\sum }_{a ∈ A [ t ]} {x}_{ra} ) ( {D}_{{c}_{r}} + 1 ) ) , 0 \} ,$$

wherein λ≥0 corresponds to a tuning parameter of the iteration. The virtual queue variable V_{c}_{ᵣ}[t] is set to be a non-negative value. As a possible starting value V_{c}_{ᵣ}[0]=0 may be selected.

In a step S16, the method includes:
At the given time t∈T_{act}, scheduling the set R[t] of computational tasks 14 among the set A[t] of computational hardware components 12 based on the determined decision variable data x[t].

The disclosure herein also comprises the task scheduling device 16 for carrying out the task scheduling method. The disclosure herein further comprises the data processing device 10, comprising such task scheduling device 16 and the plurality of computational hardware components 12. The disclosure herein further comprises an air vehicle, in particular an aircraft 18, comprising the task scheduling device 16 and/or the data processing device 10. The disclosure herein further comprises a computer program (not shown) comprising instructions which, when the program is executed by a computer, cause the computer to carry out the task scheduling method. The disclosure herein further comprises a computer-readable data carrier (not shown) having stored thereon the computer program.

Preferred embodiments of the disclosure herein can be summarized as follows:

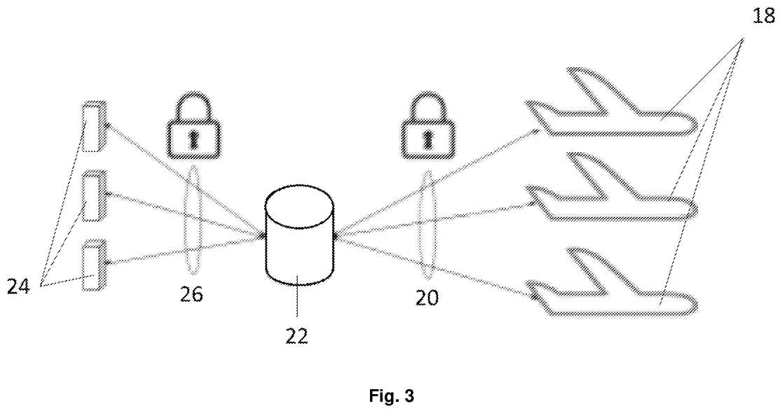

Communication links are becoming an integral part of aeronautic systems. An example that is implemented or envisioned in multiple contexts (commercial airspace as well as urban airspace) is the data upload to a cloud, as shown in FIG. 3. Here, multiple aircrafts 18, or in general air vehicles (AVs), upload telemetry or status updates 20 to a cloud server 22. On this server 22, data is processed and either fetched by end users 24 via an interaction 26 or re-distributed to the AVs. To avoid misuse, the communication links need to be secured cryptographically, to provide confidentiality, integrity and/or authentication. To do so, a public key infrastructure (PKI) based on asymmetric cryptography is often used. PKIs involve different procedures for key exchange and signature generation/verification. These procedures require the execution of computational tasks that may run on general purpose CPUs 28 or on specific hardware, such as FPGAs 30 or ICs 32. In some places, for example in the cloud 22, a high number of connections are established, which leads to a high number of times that the cryptographic functions need to be executed. To deal with this load efficiently, a multi-core and multi-accelerator setup is targeted.

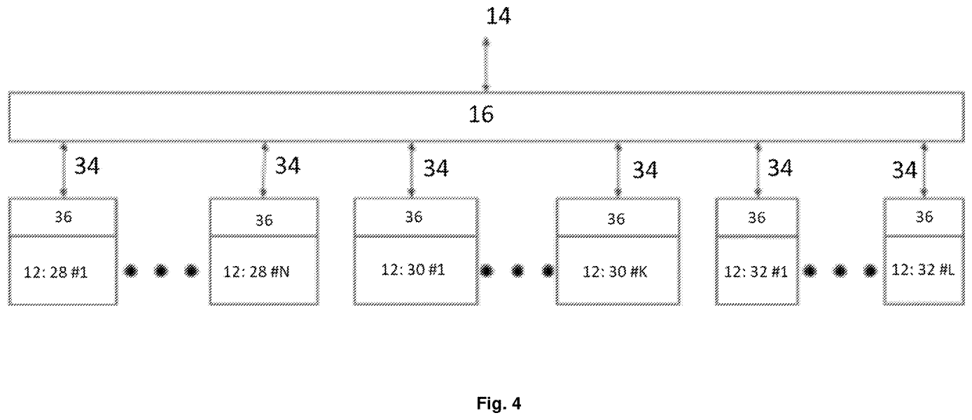

The targeted system comprises a set of hardware components 12 as shown in FIG. 4, namely one or multiple CPUs 28, one or multiple FPGAs 30 and/or one or multiple ICs 32. Each component 12 is reachable via a communication interface 34, e.g. a bus system, that can be used to transfer data and commands to it. Also, each component 12 has associated a piece of memory 36 to which it writes its output or status. The memory 36 may be either physically or logically associated with it. Finally, there is a scheduler 16, i.e., a control routine that distributes cryptographic tasks 14 to the different components 12.

It is assumed that each of the hardware components 12 has an implementation for a subset of the following cryptographic functions:
keygen—creates a pair of public and secret key,
sign—signs a specific piece of data,
verify—verifies the signature of a signed piece of data,
encaps—encapsulates a shared secret for a key exchange mechanism,
decaps—decapsulates a shared secret for a key exchange mechanism.

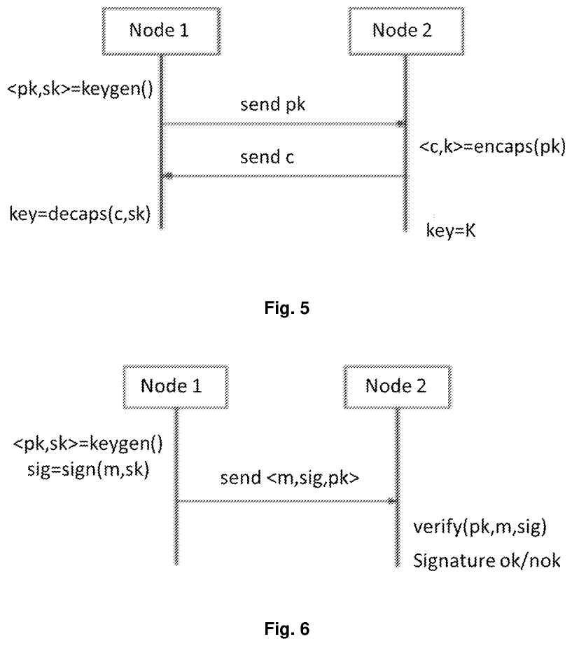

The functions can be combined to perform tasks 14 related to PKIs, e.g., symmetric key exchange, certificate generation and verification, etc. For example, the process of symmetric key exchange happens in the fashion shown in FIG. 5, while signature generation and verification happens as shown in FIG. 6, with pk being a public key, sk a secret key, m a message, sig a signature, and c a ciphertext in these figures.

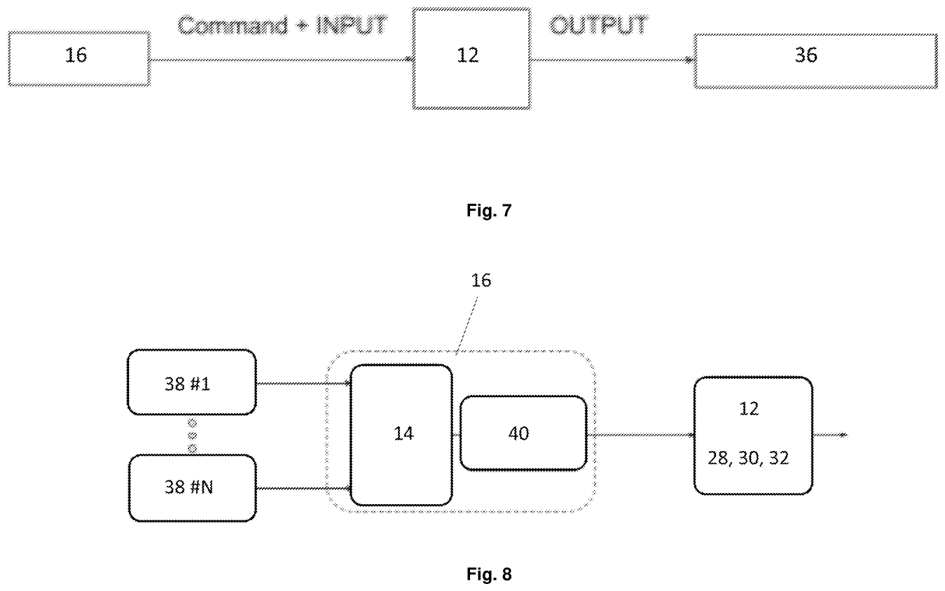

The scheduler 16 can interact with the hardware components 12, e.g., via a bus, and can issue the execution of different commands 14. The results are then fed back into the memory 36 associated with the component 12, as shown in FIG. 7.

Depending on the exact command, the INPUT and OUTPUT parts change:

| Command | INPUT | OUTPUT |
|---|---|---|
| keygen | −/− | Public Key |
| | | Secret Key |
| | | Return Code |
| encaps | Public Key | Ciphertext |
| | | Shared Secret |
| | | Return Code |
| decaps | Ciphertext | Share Secret |
| | Secret Key | Return Code |
| sign | Message | Signature |
| | Secret Key | Return Code |
| verify | Message | Return Code |
| | Signature | |
| | Public Key | |

Note that in particular realizations, additional parameters might be fed in or out, such as the length of the exchanged data fields. Also, in specific realizations, both input and output may contain an extra ID field that identifies the communication peer to which the command is associated.

When a thread 38 on the computer tries to execute a command, it passes the command 14 and input to the scheduler 16 as shown in FIG. 8. The scheduler 16 treats the command 14 and input as “request”, that it holds in an internal data structure. All requests are processed in an order that is determined by an internal scheduling routine 40. The routine 40 decides which of the requests is passed to the cryptographic function next, and to which CPU 28, FPGA 30 or IC 32 exactly it is passed. For example, the scheduling routine 40 can implement a first-in first-out queue, a priority queueing system or similar. Once a request has been processed by the cryptographic function, the output is fed back to the originating thread 38, which continues its intended operation.

Among all possible scheduling routines, two specific scheduling classes shall be mentioned in particular, namely strict priority scheduling and a utility optimizing scheduler with virtual queues.

Consider that time is grouped into discrete intervals t∈{1, 2, 3, . . . } and assume that at each interval, A[t]={1, 2, 3, . . . } is the set of available function instances (the FPGAs, ICs or CPUs that would accept a command) and R[t]={1, 2, 3, . . . } is the set of pending requests (the pending commands). Each request is part of a quality class cᵣ∈C. For each request r∈R[t] and instance a∈A[t], the time required to transfer the associated command and data, execute the function and return the output is given by Tᵣₐ. Each class and instance has associated a utility value U_{ca} that determines either the “cost” or “added value” that is induced by assigning a task of class c to it. For example, U_{ca}:=E_{ca} would indicate that assigning a task of class c to instance a induces an energy cost of E_{ca}. Likewise, a value U_{ca}:=1 would induce that assigning a task of class c to instance a adds the value of finishing off one task. At each time instance t, there is a decision variable xᵣₐ∈{0,1}, which is one if request r is allocated to instance a and zero otherwise. To be valid, the decision vector x must satisfy a set of constraints, namely that each request can be assigned to at most one function instance and that each function instance cannot have more than one request assigned. For the sake of brevity, these constraints are written as x∈F, where F is the set of valid (“feasible”) allocations.

The two schedulers then work in the following manner:
1) Strict priority scheduler: Here, the utility is a strict priority value per class, i.e., U_{ca}=P_{c}∀a, and the goal is to optimize the mathematical problem

$${max}_{x} {\sum }_{r ∈ R [ t ]} {\sum }_{a ∈ A [ t ]} {x}_{ra} {P}_{{c}_{r}} s . t . x ∈ F ,$$

which is solved by sequentially assigning the requests with highest priority first to their function of choice, then the ones with the second highest priority to the remaining ones, and so forth.
2) Virtual Queue scheduler: Here, the goal is to maximize the long-term average of the problem

$${max}_{x} {\sum }_{r ∈ R [ t ]} {\sum }_{a ∈ A [ t ]} {x}_{ra} {U}_{{c}_{r} a} s . t . {\sum }_{a ∈ A [ t ]} {x}_{ra} {T}_{{c}_{r} a} + ( 1 - {\sum }_{a ∈ A [ t ]} {x}_{ra} ) ( {D}_{{c}_{r}} + 1 ) \leq {D}_{{c}_{r}} ∀ r , x ∈ F .$$

This is done by associating a virtual queue variable V_{c} per class. After each allocation, the queue variables are updated by V_{c}_{ᵣ}:=max{V_{c}_{ᵣ}−λ(D_{c}_{ᵣ}−Σ_{a∈A[t]}xᵣₐT_{c}_{ᵣ}ₐ−(1−Σ_{a∈A[t]}xᵣₐ)(D_{c}_{ᵣ}+1)), 0}, for a given λ≥0 that may be used to fine-tune the scheduler. In each time instant, the scheduler then solves the problem

$${max}_{x} {\sum }_{r ∈ R [ t ]} {\sum }_{a ∈ A [ t ]} {x}_{ra} ( {U}_{{c}_{r} a} - {V}_{{c}_{r}} [ {T}_{{c}_{r} a} - {D}_{{c}_{r}} - 1 ] )$$

s.t. x∈F. This problem is a bipartite matching problem that may be solved with known methods, e.g., with the Hungarian method.

List of reference signs:

| | |
|---|---|
| 10 | data processing device |
| 12 | computational hardware component |
| 14 | computational task |
| 16 | task scheduling device |
| 18 | aircraft |
| 20 | telemetry or status update |
| 22 | server |
| 24 | end user |
| 26 | interaction |
| 28 | CPU |
| 30 | FPGA |
| 32 | IC |
| 34 | interface |
| 36 | memory |
| 38 | thread |
| 40 | routine |
| t | given time |
| R[t] | set of computational tasks |
| A[t] | set of computational hardware components |
| T_{act} | set of discrete time intervals each of length Δt |
| C | set of task quality classes |
| T_{proc} | processing time value |
| U_{proc} | utility value |
| Dₗᵢₘᵢₜ | computing time limit |
| xᵣₐ | decision variable |
| x | decision variable data |
| V_{c} | virtual queue variable |
| λ | tuning parameter |
| P_{proc} | priority value |

1. A computer-implemented task scheduling method for use in a data processing device with a plurality of computational hardware components and for scheduling a set R[t] of computational tasks at a given time t∈T_{act}, T_{act} being a set of discrete time intervals each of length Δt, among a set A[t] of the computational hardware components that are available at the given time t∈T_{act} and configured for executing any one of the computational tasks, each computational task being associated with a corresponding task quality class c∈C, C being a set of task quality classes, each task quality class c∈C and each computational hardware component being associated with a corresponding processing time value T_{proc} in terms of Δt, the associated processing time value T_{proc} being indicative of a duration for processing any one computational task of the corresponding class c∈C by the corresponding computational hardware component, each task quality class c∈C and each computational hardware component being further associated with a corresponding utility value U_{proc}, the associated utility value U_{proc} being indicative of a cost or added value that is induced by processing any one computational task of the corresponding class c∈C by the corresponding computational hardware component, the method comprising:
a) associating each task quality class c∈C with a corresponding computing time limit value Dₗᵢₘᵢₜ in terms of Δt;
b) at the given time t∈T_{act}, defining for each computational task r∈R[t] and each hardware component a∈A[t], a corresponding decision variable xᵣₐ[t]∈{0, 1}, wherein xᵣₐ=1, if the computational task r∈R[t] is allocated to computational hardware component a∈A[t], and xᵣₐ=0 otherwise, under the constraint that each task r∈R[t] is allocatable to at most one computational hardware component a∈A[t] and each computational hardware component a∈A[t] is to assigned at most one computational task r∈R[t];
c) at the given time t∈T_{act}, whereas cᵣ∈C being the associated task quality class c of r∈R[t], determining decision variable data x[t] by solving a maximization problem including the associated utility value U_{proc} of cᵣ∈C and a∈A[t], for all r∈R[t] and a F A[t], under a condition:
Σ_{a∈A[t]}xᵣₐ[t]T_{c}_{ᵣ}ₐ+(1−Σ_{a∈A}[t]xᵣₐ[t])(D_{c}_{ᵣ}+1)≤D_{c}_{ᵣ}, for all r∈R[t],
with x[t]∈F[t], F[t] being the set of all decision variable data satisfying the constraint in step b) at the given time t∈T_{act}, T_{c}_{ᵣ}ₐ being the associated processing time T_{proc} of cᵣ∈C and a∈A[t], and D_{c}_{ᵣ} being the associated computing time limit value Dₗᵢₘᵢₜ of cᵣ∈C; and
d) at the given time t∈T_{act}, scheduling the set R[t] of computational tasks among the set A[t] of computational hardware components based on the determined decision variable data x[t].

2. The method according to claim 1, wherein step c) comprises:
c1) at the given time t∈T_{act}, solving the maximization problem according to:
$${max}_{x [ t ]} {\sum }_{r ∈ R [ t ]} {\sum }_{a ∈ A [ t ]} {x}_{ra} [ t ] {U}_{{c}_{r} a} ,$$
with U_{c}_{ᵣ}ₐ being the associated utility value U_{proc} of cᵣ∈C and a∈A[t].

3. The method according to claim 1, wherein step c) comprises:
c2) at the given time t∈T_{act}, solving a bipartite matching problem.

4. The method according to claim 3, wherein step c) comprises:
c3) at the given time t∈T_{act}, solving the bipartite matching problem according to:
$${max}_{x [ t ]} {\sum }_{r ∈ R [ t ]} {\sum }_{a ∈ A [ t ]} {x}_{ra} [ t ] ( {U}_{{c}_{r} a} - {V}_{{c}_{r}} [ t ] [ {T}_{{c}_{r} a} - {D}_{{c}_{r}} - 1 ] ) ,$$
with U_{c}_{ᵣ}ₐ being the associated utility value U_{proc} of cᵣ∈C and a∈A[t], T_{c}_{ᵣ}ₐ being the associated processing time T_{proc} of cᵣ∈C and a∈A[t], D_{c}_{ᵣ} being the associated computing time limit value Dₗᵢₘᵢₜ of cᵣ∈C, and V_{c}_{ᵣ}[t] being a virtual queue variable of cᵣ∈C in terms of per Δt.

5. The method according to claim 4, wherein step c) comprises:
c4) at the given time t∈T_{act}, iteratively computing for each class cᵣ∈C the associated virtual queue variable V_{c}_{ᵣ}[t] in terms of per Δt according to:
$${V}_{{c}_{r}} [ t ] = {max}_{x [ t ]} \{ {V}_{{c}_{r}} [ t - Δ t ] - λ ( {D}_{{c}_{r}} - {\sum }_{a ∈ A [ t ]} {x}_{ra} [ t - Δ t ] {T}_{{c}_{r} a} - ( 1 - {\sum }_{a ∈ A [ t ]} {x}_{ra} ) ( {D}_{{c}_{r}} + 1 ) ) , 0 \} ,$$
wherein λ≥0 corresponds to a tuning parameter of the iteration.

6. The method according to claim 1, wherein the associated computing time limit value Dₗᵢₘᵢₜ corresponds to an average duration for processing any one computational task of the corresponding class c∈C by each of the computational hardware components in the data processing device.

7. The method according to claim 1, wherein the associated utility value U_{proc} corresponds to an associated priority value P_{proc} indicative of a priority that has every computational task of the corresponding class c∈C on the corresponding computational hardware component and/or wherein the associated utility value U_{proc} corresponds to an associated priority value P_{proc} indicative of a priority that has every computational task of the corresponding class c∈C on each of the computational hardware components in the data processing device.

8. The method according to claim 1, wherein each computational task includes a cryptographic computation function.

9. A task scheduling device for carrying out the method of claim 1.

10. A data processing device, comprising the task scheduling device of claim 9 and a plurality of computational hardware components.

11. The data processing device of claim 10, wherein the plurality of computational hardware components include one or more of a CPU, a GPU, a FPGA, an IC.

12. The data processing device of claim 11, wherein at least two of the plurality of computational hardware components have for at least one task quality class c ∈C differing corresponding processing time values T_{proc} and/or differing corresponding processing time values U_{proc}.

13. An air vehicle or an air vehicle that is an aircraft, comprising the task scheduling device of claim 9.

14. A computer program comprising instructions which, when the program is executed by a computer, cause the computer to carry out the method of claim 1.

15. A computer-readable data carrier having stored thereon the computer program of claim 14.
